(19) United States
(12) Patent Application Publication
(10) Pub. No.: US 2026/0225478 A1
(43) Pub. Date: Aug. 6, 2026

(54) METHOD FOR OPERATING A CHARGING SYSTEM COMPRISING INDUCTION CHARGING DEVICES

(71) Applicant: MAHLE International GmbH, Stuttgart (DE)

(72) Inventor: Mike Boettigheimer, Kornwestheim (DE)

(21) Appl. No.: 19/148,310

(22) PCT Filed: Jan. 4, 2024
(86) PCT No.: PCT/EP2024/050169

§ 371 Date: Jul. 15, 2025

(30) Foreign Application Priority Data
Jan. 16, 2023 (DE) 10 2023 200 292.2

(51) Int. Cl. B60L 53/126; B60L 53/38; B60L 53/66; H02J 50/10; H02J 50/80; H02J 50/90; H02J 107/20

(52) U.S. Cl. CPC B60L 53/126; B60L 53/38; B60L 53/66; H02J 50/10; H02J 50/80; H02J 50/90; H02J 2107/20

(57) ABSTRACT

A method for operating a charging system with stationary and mobile induction charging devices is disclosed. The method includes aligning the devices for inductive energy transfer and, prior to charging, designating one device as a transmitter and the other as a receiver. The transmitter sends its identifier (ID) via an ID field along the alignment axis, allowing the receiver to establish a data connection based on the received ID, thereby enabling efficient and straightforward charging operations.

### CROSS REFERENCE TO RELATED APPLICATIONS

This application claims priority to International Patent Application No. PCT/EP2024/050169, filed on Jan. 4, 2024, and German Patent Application No. 102023200292.2, filed on Jan. 16, 2023, the contents of both of which are hereby incorporated by reference in their entirety.

### TECHNICAL FIELD

The present disclosure relates to a method for operating a charging system, wherein the charging system comprises at least one stationary induction charging device and at least one mobile induction charging device, and wherein the respective stationary induction charging device can interact inductively with one of the at least one mobile induction charging devices in a charging operation for inductive energy transfer. The disclosure also relates to a charging system operated in this manner.

### BACKGROUND

For inductive and therefore wireless energy transfer, two induction charging devices can interact inductively. One of the induction charging devices can be stationary and the other mobile. For energy transfer, the two induction charging devices must be positioned relative to each other. The operation in which the induction charging devices that transfer energy to each other interact is also referred to below as charging operation. A charging system may comprise several such stationary induction charging devices and/or several such mobile induction charging devices, wherein the respective stationary induction charging device is capable of transferring energy to the respective mobile induction charging device by means of induction. During charging operation, in addition to inductive energy transfer, communication between the interacting induction charging devices is necessary or at least advantageous.

### SUMMARY

The present disclosure relates to the task of specifying improved or at least different embodiments for a method for operating a charging system of the type mentioned above and for such a charging system. In particular, the present disclosure deals with the task of providing improved or at least alternative embodiments for the method and for the charging system, which are characterized by user-friendly and at the same time simple implementation.

The disclosure solves this problem by the scope of the independent claims. Advantageous embodiments are the scope of the dependent claims.

The present disclosure is based on the general idea of transmitting an identifier of the induction charging device to the other induction charging device in a charging system for data connection between a stationary induction charging device that interacts inductively for the purpose of inductive energy transfer and a mobile induction charging device with one of the induction charging devices by means of a local field, wherein the other induction charging device receives the identifier and a data connection between the induction charging devices is established using the received identifier. The transmission of the identifier, hereinafter also referred to as ID for short, via the local field means that the induction charging devices can be assigned for inductive energy transfer immediately when the induction charging devices approach each other and the data connection can be established accordingly. This means that a mobile induction charging device can position itself at a stationary induction charging device without prior manual selection, and the data connection is established via the ID due to the local field during positioning. This means that the mobile induction charging device or an associated application does not have to determine/decide in advance which stationary induction charging device to use to establish the data connection. As a result, the data connection between the induction charging devices is user-friendly and easily implemented. If the determination/decision is to be made manually, this leads to further user-friendly implementation, since the inventive concept allows a user of the mobile induction charging device to bring the induction charging devices that are to interact closer together without prior manual selection and without prior connection establishment between the induction charging devices. If the charging system has two or more stationary induction charging devices and/or two or more mobile induction charging devices, these can, as described above, transfer energy inductively to each other in a user-friendly manner. On the other hand, transferring the ID using the local field means that only the ID of the induction charging device that generated the local field is received. This results in further user-friendly implementation and less fault-prone, and therefore more robust, operation of the charging system.

In accordance with the inventive concept, the charging system comprises at least one stationary induction charging device and at least one mobile induction charging device. The respective stationary induction charging device is capable of interacting inductively with the respective at least one mobile induction charging device for inductive energy transfer. This means that the respective stationary induction charging device interacts inductively with one of the at least one mobile induction charging devices during charging operation for inductive energy transfer. During charging operation, the inductively interacting induction charging devices, i.e., the stationary induction charging device and the mobile induction charging device, are arranged opposite each other in one direction, which is hereinafter also referred to as the first direction. Before charging operation, when the induction charging devices that are to interact inductively approach each other, one of the induction charging devices is operated as a transmitting induction charging device and the other induction charging device is operated as a receiving induction charging device. The transmitting induction charging device generates at least one field that transmits an ID of the transmitting induction charging device and whose main axis runs along the first direction. The receiving induction charging device receives the ID of the transmitting induction charging device by means of at least one field, wherein a data connection is established between the transmitting induction charging device and the receiving induction charging device by means of the ID of the transmitting induction charging device received by the receiving induction charging device.

The data connection between the transmitting induction charging device and the receiving induction charging device can use at least one of the at least one fields transmitting the ID.

It is advantageous for the data connection between the transmitting induction charging device and the receiving induction charging device to be separate from the at least one field transmitting the ID.

The data connection between the transmitting induction charging device and the receiving induction charging device is conveniently maintained during the subsequent charging operation. This means that the data connection remains active during subsequent charging operations.

The field with which the transmitting induction charging device transmits its ID is referred to below as the ID field.

The transmission of the ID from the transmitting induction charging device to the receiving induction charging device advantageously corresponds to the so-called “pairing” or is part of the pairing.

The data connection between the induction charging devices that are to interact in charging operation, hereinafter also referred to as associated induction charging devices, can in principle be established in any manner, wherein the data connection is preferably established separately from the at least one ID field for ID transmission.

It is advantageous for the data connection of the at least one mobile induction charging device to be wireless, advantageously via WiFi, and preferably via WLAN. The data connection with the stationary induction charging device can also be established via WiFi or a wired connection.

The charging system has the appropriate infrastructure for establishing the data connection and for connecting the induction charging devices to each other. The infrastructure conveniently includes a data network, hereinafter referred to as the network for short. The infrastructure may include appropriate access points and/or at least one router.

Advantageously, the charging system comprises a server as part of the infrastructure, on which the IDs of at least the at least one transmitting induction charging device are stored.

As explained above, the ID corresponds to an identifier or identifier information. The ID allows the transmitting induction charging device to be clearly identified.

In principle, the ID can contain any information. It is conceivable that the ID includes or consists of a MAC address of the transmitting induction charging device. Alternatively or additionally, the ID may include or consist of an IP address and/or an identifier of the infrastructure of the charging system, in particular of the network in which the transmitting induction charging device is integrated. The identifier can function in particular as an SSID. The identifier can prevent or at least reduce incorrect pairings if the same IP is assigned to two transmitting induction charging devices in different infrastructures, in particular networks.

Pairing and/or data connection should preferably be carried out in accordance with standards such as “ISO 15118-20.”

The data connection between the associated induction charging devices enables communication between them. The data connection can be used, for example, to adjust operating points and/or operating parameters of the associated induction charging devices in order to improve the charging operation.

The respective induction charging device has a coil for inductive energy transfer, which will be referred to below as an energy coil. During charging operation, one of the energy coils acts as the primary coil and the other energy coil as the secondary coil. This means that bidirectional, inductive energy transfer is also possible.

The arrangement of the associated induction charging device in charging operation, which is opposite to the first direction, relates appropriately to the energy coils.

“Opposite” does not necessarily mean directly opposite. Rather, the induction charging device or energy coils are spaced apart from each other in the first direction, preferably in such a way that they overlap transversely to the first direction.

The course of the main axis of the field along the first direction means, in particular, that the field is generated in such a way that the field propagates at least predominantly in or along the first direction.

The respective mobile induction charging device is preferably attached to an associated mobile application, in particular to a motor vehicle. Preferably, energy is transferred inductively to the application by means of the mobile induction charging device, for example to charge a battery of the application, in particular of the motor vehicle.

The first direction preferably corresponds to a height direction of the application and, in particular, to a Z direction of the motor vehicle.

The respective at least one ID field for wireless transmission of the ID can in principle be any field.

In particular, it is conceivable to create a separate ID field specifically for this purpose in order to transmit the ID.

In preferred embodiments, at least one of the at least one fields used to transmit the ID also serves another function.

Advantageous embodiments are those in which, in a positioning operation starting before the charging operation, the transmitting induction charging device of at least one of the at least one ID fields generates at least one of the at least one ID fields as a field for positioning the induction charging devices relative to each other, hereinafter also referred to as the positioning field, in order to position the induction charging devices that are to interact inductively with each other for inductive energy transfer. This means that at least one of the at least one ID fields transmitting the ID is such a positioning field. Preferably, at least one ID field is such a positioning field. The receiving induction charging device receives the at least one positioning field, wherein the relative position of the transmitting induction charging device with respect to the receiving induction charging device is determined by means of the at least one received positioning field. This means that at least one of the ID fields generated as positioning fields also transmits the ID of the transmitting induction charging device. In other words, at least one of the at least one fields is used both to transmit the ID and to determine the relative position of the transmitting induction charging device with respect to the receiving induction charging device.

Since the main axis of the ID field runs along the first direction, the at least one positioning field is used to determine the relative position of the transmitting induction charging device to the receiving induction charging device locally and thus close to the transmitting induction charging device, i.e., when the mobile induction charging device is already approaching the stationary induction charging device.

Preferably, the ID is transmitted by modifying the positioning field. This means that the transmitting induction charging device transmits the ID by means of a modification of at least one of the at least one positioning fields. This means that the positioning and transmission of the ID can take place without or at least with minimal time delay, i.e., without or with at least reduced latency.

In this context, “modification” refers in particular to a change to at least one positioning field which is not required to determine the relative position.

The modification can be of any kind.

In particular, the modification may be a modulation, for example a modulation of the frequency and/or the duty cycle.

The modification is preferably a temporary, preferably repeated change. The modification is therefore preferably a change for a specific period of time, which is advantageously repeated at time intervals, preferably at predetermined time intervals.

Advantageous embodiments are those in which the at least one positioning field is modified by means of a change at predetermined time intervals. The time intervals at which the positioning field is changed for ID transmission are therefore predetermined. This simplifies the transmission of the ID and also simplifies the determination of the relative position of the transmitting induction charging device with respect to the receiving induction charging device by means of the at least one positioning field.

The specified time intervals can be as long as desired, provided that they still allow the relative position of the transmitting induction charging device to the receiving induction charging device to be determined. In particular, the time intervals may vary. It is advantageous if the time intervals are equal.

Variants with time intervals of several milliseconds have proven to be advantageous. It is particularly conceivable that the time intervals are 50 ms, 100 ms, and the like. Such time intervals lead to particularly reliable transmission of both the ID and, at the same time, minimized time delay in determining the relative position due to the modification of the positioning field.

It is understood that the time intervals and/or the duration of the respective modification may be distorted, in particular prolonged or shortened, due to possible inertia of the transmitting induction charging device, in particular due to so-called “dead times,” in the receiving induction charging device. It is further understood that such distortions shall be taken into account.

It is conceivable to implement the modification of at least one of the at least one positioning field by changing the frequency of the positioning field, for example by means of frequency modulation, in particular at predetermined time intervals.

Preferred embodiments are those in which the transmitting induction charging device transmits the ID by means of a preferably temporary change in the amplitude of at least one of the at least one positioning fields at predetermined time intervals. Modification by changing the amplitude allows easy detection of ID transmission on the receiving induction charging device, i.e., a defined and simple separation between ID transmission and the actual positioning field, in particular compared to modification via frequency. This increases reliability while simplifying implementation.

The amplitude can be changed in particular by increasing the amplitude.

The amplitude is preferably changed by means of a reduction in amplitude, preferably temporary, preferably by suspending the amplitude and thus the positioning field. This ensures that the ID transmission is clearly recognized and also clearly separated from the positioning field. This means that the ID can be transmitted simply and reliably, while at the same time ensuring simple and reliable separation between the transmission of the ID and the actual positioning field.

The ID is conveniently transmitted by transmitting a code containing the ID together with the at least one ID field.

The code can be of any type.

In preferred embodiments, the code is a binary code. This means that the transmitting induction charging device transmits the ID using a binary code. The binary code is composed of first symbols and second symbols. The use of binary code to transmit the ID results in reduced susceptibility to interference and thus more reliable transmission of the ID, making the transmission of the ID more robust.

The first symbol and the second symbol can each be of any type.

For example, the first symbol may be a logical zero or “false” and the second symbol may be a logical one or “true,” or vice versa.

In advantageous embodiments, the first symbol is transmitted by a temporary change of at least one of the at least one positioning field and the second symbol by an omission of the temporary change. Preference is given to transmitting the symbols at the specified time intervals.

In preferred embodiments, the first symbol is transmitted by temporarily suspending at least one of the at least one positioning field, and the second symbol is transmitted by not suspending the positioning field. Preference is given to transmitting the symbols at the specified time intervals. This means that the ID can be composed of a sequence of first and second symbols of any length and can be transmitted easily, robustly, and reliably.

In particularly preferred embodiments, the ID is transmitted by means of at least one of the at least one positioning field and with the binary code, wherein preferably at said time intervals the first symbol is transmitted by temporarily suspending the amplitude and the second symbol by a failure of the suspension, or vice versa.

Embodiments are also preferred in which the symbols are transmitted by means of different durations of the change of at least one of the at least one positioning fields. This means that a change in the at least one positioning field for a first period transfers the first symbol, and a change, in particular the same change, in the at least one positioning field for a second period transmits the second symbol.

The first duration and the second duration are appropriately different. It is advantageous if the second duration is a whole multiple of the first duration or vice versa. For example, the first duration is 1 ms and the second duration is 2 ms or 3 ms.

The change preferably involves suspending the amplitude of at least one positioning field. This means that, in preferred embodiments, the first symbol is transmitted by suspending the amplitude of at least one of the at least one positioning field for a first duration and the second symbol is transmitted by suspending the amplitude of the at least one positioning field for a second duration. This ensures particularly reliable and robust transmission of the symbols.

The time interval specifies the intervals at which the positioning field contains a symbol of the binary code. If the time intervals are 50 ms, for example, a symbol is transmitted every 50 ms.

The same applies to temporary changes and therefore to the duration. If the duration is 1 ms, for example, a symbol is transmitted at the time intervals by changing the positioning field for 1 ms. For example, a logical zero or “false” is transmitted with suspending the amplitude at time intervals of 50 ms for 1 ms. A logical one or “true” is transmitted if this suspension does not occur within a time interval of 50 ms.

The transmitting induction charging device advantageously transmits the start and/or end of the ID transmission.

The transmission of the start and/or end of the ID transmission allows, in particular, an ID of variable length to be transmitted. For example, it may be necessary to select the ID to be longer than in the case of a lower number of adjacent stationary induction charging devices as transmitting induction charging devices, due to an increased number of adjacent stationary induction charging devices as transmitting induction charging devices. The respective variable length of the receiving induction charging device is communicated with the transmission of the start and/or end, so that the receiving induction charging device recognizes the ID in each case.

It is conceivable to make a different modification to the positioning field at the start of ID transmission. For example, the amplitude can be suspended for a different duration, such as 2 ms.

The end of the ID transmission can be transmitted in the same way as the start, with one modification. For example, the amplitude can be modified for a different duration. In particular, the amplitude can be suspended for 3 ms.

The ID can also be transmitted periodically, i.e., the binary code can be transmitted periodically and repeatedly.

In particular, in the case of periodic transmissions, the start of the transmission may correspond to the end.

In this case, the field in question is a physical field, i.e., a generated signal that is received by the other side. In the present case, the transmitting induction charging device generates the respective field, which is a signal that is received by the receiving induction charging device. In other words, the ID field is an ID signal generated by the transmitting induction charging device, which transmits the ID and which is received by the receiving induction charging device. In addition, the respective positioning field is a positioning signal generated by the transmitting induction charging device, which is received by the receiving induction charging device. Consequently, the positioning signal is modified to transmit the ID by means of a modification of the positioning field.

The respective at least one ID field, in particular positioning field, can be a field of any type.

In preferred embodiments, the transmitting induction charging device generates at least one of the at least one ID field, in particular positioning fields, preferably the respective ID field, in particular the respective positioning field, as a magnetic field. This means that at least one of the at least one ID fields, preferably the respective ID field, is a magnetic field. This results in simple generation of the ID field and simplified local processing, in particular reduced processing transverse to the first direction.

To generate the respective magnetic field, the transmitting induction charging device preferably has at least one coil, hereinafter also referred to as a transmission coil. In particular, the transmitting induction charging device for generating the respective ID field, in particular the respective positioning field, may have an associated transmission coil.

Advantageous are embodiments in which at least one of the at least one transmission coils, preferably the respective transmission coil, is different from the energy coil of the transmitting induction charging device.

The receiving induction charging device can have a corresponding receiver for receiving the at least one ID field, in particular the at least one positioning field. In particular, the receiver may have at least one coil, hereinafter also referred to as the receiving coil, for receiving the at least one ID field.

The receiver, in particular the receiving coil, is conveniently operated at a sampling rate. This involves determining several values within a sampling interval and averaging these values.

The duration of the suspension for modification corresponds preferably to a sampling interval of the receiver, in particular of the receiving coil. This prevents or at least reduces latency when positioning the induction charging devices.

In preferred embodiments, at least one of the at least one positioning fields is generated as a magnetic field by means of a signal at the associated transmission coil, wherein the modification is generated by means of a change in the signal. The signal may be pulse width modulation, or “PWM” for short, preferably with a constant duty cycle. The modification is therefore generated by means of a temporary change to the PWM. This makes it easy to transmit the ID.

The transmitting induction charging device can, in principle, generate a single positioning field of this kind.

Preferred embodiments are those in which the transmitting induction charging device generates at least two positioning fields that are spatially offset from one another. This enables simplified and more precise determination of the relative position of the associated induction charging devices in relation to each other.

It may be useful for the receiving induction charging device or the associated application to be able to distinguish between the positioning fields. For this purpose, the respective positioning field can be generated with an associated frequency, for example.

To determine the relative position of the induction charging devices to each other, the locally received ratio between the at least two positioning fields can be determined. This enables simplified and reliable determination of the relative position, especially without prior calibration.

In order to position the induction charging devices relative to one another for increased efficiency of inductive energy transfer, i.e., for optimal positioning of the induction charging devices during charging operation, a navigation instruction is advantageously generated and output on the basis of the at least one positioning field, in particular on the basis of the at least one ratio.

The respective navigation instruction can be used for the relative movement of the mobile induction charging device or an associated application, for example an associated motor vehicle, relative to the stationary induction charging device. It is conceivable that the respective navigation instruction could be made available to a driver who is able to drive the motor vehicle in accordance with the navigation instruction, in particular to steer it. Alternatively or additionally, the respective navigation instruction can be issued to a driver assistance system for at least partially autonomous driving of the motor vehicle, so that the driver assistance system drives the motor vehicle at least semi-autonomously by means of the navigation instruction for positioning the induction charging devices relative to each other.

The ID is advantageously transmitted by means of simultaneous modification of at least two of the at least two positioning fields. This results in less interference-prone transmission of the ID and less interference-prone positioning.

Embodiments are conceivable in which the ID is transmitted by means of a predetermined sequence of modifications of at least two of the at least two positioning fields. This distributes the transmission of the ID to the positioning fields so that the positioning fields only need to be modified for a shorter period of time. This leads to reduced delay in determining the relative position of the induction charging devices to each other and consequently to reduced latency in determining the relative position. In this way, the latency in determining the relative position is reduced, on the one hand. The specified sequence of modifications of the at least two positioning fields can be of any kind. The sequence should preferably be periodic. This means that the ID is transmitted by means of a periodic sequence of modifications to the at least two positioning fields. This results in reliable and robust transmission of the ID.

Preferred embodiments are those in which the transmitting induction charging device generates at least four, in particular five, such positioning fields that are spatially offset from one another. In addition to improved determination of the relative position of the induction charging devices to each other, this leads to simplified and more reliable transmission of the ID.

In principle, the charging system can comprise a single stationary induction charging device.

The charging system preferably has two or more stationary induction charging devices which are adjacent to and spaced apart from each other, for example arranged in rows.

The respective stationary induction charging device is advantageously assigned to a parking space of a parking lot. This means that the charging system comprises a corresponding stationary induction charging device for at least two parking spaces of the parking lot.

The charging system can include any number of stationary induction charging devices, each for an associated parking space. It is conceivable to have tens, hundreds, or even thousands of stationary induction charging devices, each with its own ID. As explained above, the length of the ID may increase with the number of stationary induction charging devices as transmitting induction charging devices in order to be able to transmit a unique ID in each case.

The parking lot is advantageously designed for motor vehicles which, as mobile applications, are each equipped with a corresponding mobile induction charging device.

The operating method enables the respective motor vehicle to drive up to any of the parking spaces equipped with such a stationary induction charging device without prior selection in order to transfer energy inductively with the stationary induction charging device. It is therefore not necessary to select/determine in advance which of the available parking spaces or stationary induction charging devices for inductive energy transfer will be or has been approached in order to establish a reliable data connection. As a result, user-friendliness for motor vehicle drivers is increased and/or the operation of motor vehicles is simplified.

In principle, the respective mobile induction charging device and the respective stationary induction charging device can be operated both as a transmitting induction charging device and as a receiving induction charging device, provided that one of the induction charging devices to be operated together is operated as a transmitting induction charging device and the induction charging device is operated as a receiving induction charging device.

Advantageous are embodiments in which the stationary induction charging devices are each operated as such a transmitting induction charging device and the mobile induction charging devices are each operated as such a receiving induction charging device, or vice versa. The induction charging devices are equipped accordingly.

In preferred embodiments, the respective stationary induction charging device is operated as such a transmitting induction charging device and the respective mobile induction charging device is operated as such a receiving induction charging device.

It is understood that, in addition to the method, a charging system operated in this manner as such is also included within the scope of this disclosure.

In addition to the induction charging devices, the charging system also includes the infrastructure.

The infrastructure is preferably connected to the respective stationary induction charging device and can be connected wirelessly to the respective mobile induction charging device. The communication link between the infrastructure and the respective induction charging device differs from the at least one ID field, in particular from the respective positioning field. As explained above, the communication link is advantageously established wirelessly, preferably via WiFi, with at least one mobile induction charging device.

The communication link with the respective stationary induction charging device can be wireless or wired.

The charging system may comprise at least two stationary induction charging devices spaced apart from each other, each for a corresponding parking space of a parking lot.

The respective stationary induction charging device can be installed anywhere in the associated parking space. It is conceivable that at least one of the stationary induction charging devices is located at least partially, preferably entirely, below the associated parking space.

Other important features and advantages of the disclosure can be seen from the dependent claims, from the drawings, and from the associated description of the figure based on the drawings.

It is understood that the above-mentioned features and those yet to be explained below can be used not only in the combination indicated in each case, but also in other combinations or on their own, without deviating from the scope of the present disclosure.

Preferred exemplary embodiments of the disclosure are shown in the drawings by way of example and will be explained in more detail in the following description, wherein identical reference signs refer to identical or similar or functionally identical elements.

### BRIEF DESCRIPTION OF THE DRAWINGS

The drawings show, schematically in each case, in

FIG. 1 a highly simplified, circuit diagram-like representation of a charging system in a charging operation of two induction charging devices,

FIG. 2 a highly simplified top view of the charging system,

FIG. 3 a simplified cross-section of a stationary induction charging device of the charging system,

FIG. 4 a diagram for controlling a transmission coil of the stationary induction charging device, and

FIG. 5 a diagram for controlling a transmission coil of the stationary induction charging device in another exemplary embodiment.

### DETAILED DESCRIPTION

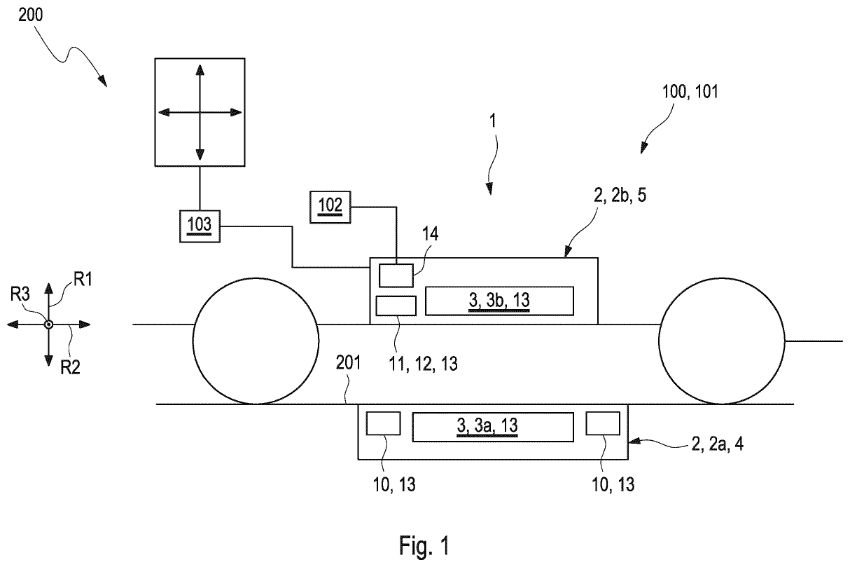

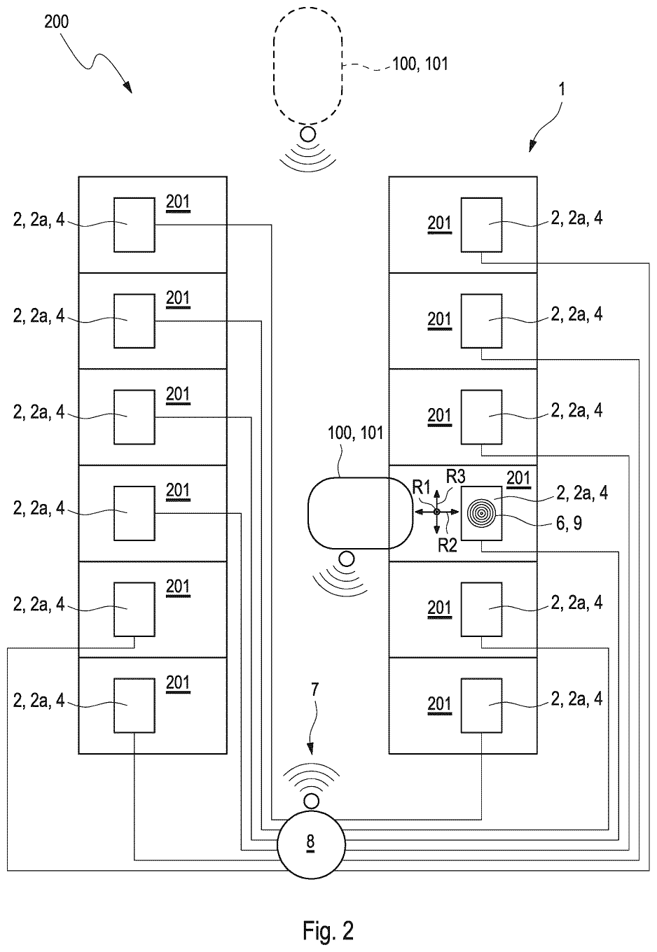

A charging system 1, as shown in FIGS. 1 and 2, is used for inductive energy transfer by means of induction. For this purpose, the charging system 1 has at least two induction charging devices 2, namely at least one stationary induction charging device 2, 2a and at least one mobile induction charging device 2, 2b. In a charging operation shown in FIG. 1, the respective stationary induction charging device 2, 2a can interact inductively with one of the at least one mobile induction charging devices 2, 2b for inductive energy transfer. During charging operation, the respective stationary induction charging device 2 is thus a charging point of the charging system 1. For inductive energy transfer, the respective induction charging device 2, as shown in FIG. 1 in particular, has a coil 3, which will also be referred to below as an energy coil 3. Thus, the respective stationary induction charging device 2, 2a has a stationary energy coil 3, 3a and the respective mobile induction charging device 2, 2b has a mobile energy coil 3, 3b. One of the energy coils 3 serves as a primary coil during charging operation, which generates an alternating magnetic field that induces a voltage in the other energy coil 3, which serves as a secondary coil, for energy transfer. As can be seen in FIG. 1, during charging operation, the induction charging devices 2, in particular the energy coils 3 of the induction charging device 2, which interact inductively for energy transfer, are spaced apart from each other in a direction R1 and arranged opposite each other, which is subsequently also referred to as the first direction R1. In the exemplary embodiments shown, the respective mobile induction charging device 2, 2b is provided in an associated mobile application 100. In the exemplary embodiments shown, the application 100 is a motor vehicle 101. In the exemplary embodiments shown, the first direction R1 runs along, in particular parallel to, the Z direction of the motor vehicle 101. The first direction R1 therefore corresponds in particular to a height direction. In addition, in order to enable charging operation and achieve high efficiency during charging operation, the energy coils 3 are positioned relative to each other transversely to the first direction R1, i.e., in a second direction R2 extending transversely to the first R1 and in a third direction R3 extending transversely to the first direction R1 and transversely to the second direction R2. In this position, the energy coils 3 preferably overlap at least partially in the second direction R2 and in the third direction R3. In the second direction R2, the exemplary embodiments shown are the direction of travel of the mobile application 100 or the motor vehicle 101, i.e., the X-direction of the motor vehicle 101. As shown in FIG. 1, energy can be transferred inductively to the mobile induction charging device 2, 2b, in particular, in order to charge a battery 102 of the mobile application 100. For this purpose, a rectifier 14 can be provided between the mobile energy coil 3, 3b and the battery 102, which converts the voltage induced in the mobile energy coil 3, 3b into a rectified voltage. In the exemplary embodiment shown, the rectifier 14 is purely an example of a component of the mobile induction charging device 2, 2b. The energy transfer can also take place from the mobile induction charging device 2, 2b to the stationary induction charging device 2, 2a, i.e., in principle also bidirectionally.

When the induction charging devices 2, which are to interact with each other in charging operation, approach each other as indicated in FIG. 2, i.e., when a mobile induction charging device 2, 2b approaches a stationary induction charging device 2, 2a for energy transfer by means of induction, and before charging operation, one of the induction charging devices 2 to be used together in charging operation is operated as a transmitting induction charging device 4 and the other induction charging device 2 as a receiving induction charging device 5. As the induction charging devices 2, which are to interact with each other during charging operation, approach each other and before charging operation begins, one of the induction charging devices 2 acts as a transmitting induction charging device 4 and the other induction charging device 2 acts as a receiving induction charging device 5. In the exemplary embodiment shown, when the mobile application 100 approaches one of the at least one stationary induction charging devices 2, 2a, this stationary induction charging device 2, 2a acts as a transmitting induction charging device 4 and the mobile induction charging device 2, 2b of the mobile application 100 acts as a receiving induction charging device 5, or vice versa. In the exemplary embodiments shown, the stationary induction charging device 2, 2a is operated as a transmitting induction charging device 4 and the mobile induction charging device 2, 2b is operated as a receiving induction charging device 5. The transmitting induction charging device 5 generates at least one field 6, indicated in FIG. 2 as a coil, and thus a signal whose main axis runs along the first direction R1 and which transmits an identifier or “ID” of the transmitting induction charging device 4. Field 6 is also referred to as ID field 6 below. Due to the course of the main axis of at least one ID field 6 along the first direction, there is only local transmission of the ID, so that the at least one ID field 6, and thus the ID, can only be received by the receiving induction charging device 5 when the receiving induction charging device 5 approaches the transmitting induction charging device 4. The receiving induction charging device 5 receives the ID of the transmitting induction charging device 4 when it approaches by means of the at least one ID field 6. Using the ID of the transmitting induction charging device 4 received by the receiving induction charging device 5, a data connection is then established between the transmitting induction charging device 4 and the receiving induction charging device 5, which in the exemplary embodiments shown is separate from the ID field 6. This means that, by means of the ID of the transmitting inducting charging device 4 received by the receiving induction charging device 5, a data connection separate from the ID field 6 is established between the transmitting induction charging device 4 and the receiving induction charging device 5. With at least one ID field 6 and the ID transmitted thereby, a locally enabled and locally limited “pairing” in the area of the transmitting induction charging device 4 takes place between the induction charging devices 2 that are to interact with each other in the subsequent charging operation. It is therefore not necessary to select or decide in advance which induction charging devices 2 are to interact with each other. In the exemplary embodiment shown, this means that in the mobile application 100, it is not necessary to decide or select in advance which stationary induction charging device 2, 2a will interact with the mobile induction charging device 2, 2b associated with the application 100 during charging operation. The data connection is established when the induction charging devices that are to interact with each other are already close to each other, making the mobile application 100 or the associated mobile induction charging device 2, 2b more user-friendly. This makes charging system 1 more user-friendly. Due to the local transmission of the ID of the transmitting induction charging device 5, there is also less susceptibility to interference and, consequently, more robust and improved operation of the charging system 1.

As can be seen in FIG. 2, in the exemplary embodiment shown, the charging system 1 comprises at least two stationary induction charging devices 2, 2a spaced apart from each other, each for a corresponding parking space 201 of a parking lot 200. For at least two of the parking spaces 201, a corresponding stationary induction charging device 2, 2a is therefore provided, which is arranged at the corresponding parking space 201. In the exemplary embodiment shown, the parking lot 200 comprises, purely by way of example, two rows of parking spaces 201, which are arranged in succession along the respective row and, by way of example, adjoin one another. In the exemplary embodiment shown, the respective parking space 201 is equipped with an associated stationary induction charging device 2, 2a of the charging system 1. As can be seen in FIG. 1, the respective stationary induction charging device 2, 2a can be arranged below the associated parking space 201. The stationary induction charging devices 2, 2a are nevertheless visible in the illustration in FIG. 2. The solution according to the disclosure offers the particular advantage that, when the mobile application 100 is driven to the parking lot 200, as indicated by the dashed line in FIG. 2, or previously in the application 100 or the associated mobile induction charging device 2, 2b, no preselection or selection of a specific stationary induction charging device 2, 2a needs to be made, with which energy is then inductively transferred during charging operation. This means that mobile application 100 can approach any of the available stationary induction charging devices 2, 2a, in the example shown, any of the free parking spaces 201. Only due to the purely local transmission of the ID of the transmitting induction charging device 4, the ID of the transmitting induction charging device 4, in this case the ID of the stationary induction charging device 2, 2a, is received by the receiving induction charging device 5, in this case the mobile induction charging device 2, 2a, only when driving into the parking space 201 and thus approaching the stationary induction charging device 2, 2a belonging to the parking space 201, and then the data connection is established between the transmitting induction charging device 4 and the receiving induction charging device 5 and consequently the inductively interacting induction charging devices 2 during charging operation.

As indicated in FIG. 2, the charging system 1 in the exemplary embodiment shown comprises an infrastructure 7 for establishing the data connection. In the exemplary embodiments shown, the data connection, which differs from at least one ID field 6, is established via WiFi, preferably WLAN, as indicated in FIG. 2, wherein the infrastructure 7 has at least one access point 8, as indicated in FIG. 2, for this purpose. For simplicity, FIG. 2 assumes that charging system 1 has a single access point 8. As further indicated in FIG. 2, the infrastructure 7 is also connected to the respective stationary induction charging device 2, 2a. This communication link can be wired or wireless. It is also conceivable that at least one of the stationary induction charging devices 2, 2a has an associated access point 8 (not shown).

The ID of the respective transmitting induction charging device 4 may, for example, contain a MAC address and/or an IP address and/or an identifier of a network of the infrastructure 7, which is not shown further, in which the transmitting induction charging device 4 is integrated.

In the exemplary embodiments shown, the transmitting induction charging device 4, and thus the respective stationary induction charging device 2, 2a in the exemplary embodiments shown, generates at least one positioning field 9 (see FIG. 2) in a positioning operation, and thus a positioning signal for positioning the induction charging devices 2, which are to interact inductively with each other for inductive energy transfer, relative to each other. Positioning operation starts before charging operation. In positioning operation, the transmitting induction charging device 4 generates at least one positioning field 9, which is received by the receiving induction charging device 5. The received at least one positioning field 9 is used to determine the relative position of the transmitting induction charging device 4 to the receiving induction charging device 5 and thus the induction charging devices 2 interacting with each other in the charging operation. In doing so, the transmitting induction charging device 4 generates at least one of the at least one ID fields 6 as such a positioning field 9. This means that both the transmission of the ID and the determination of the relative position of the transmitting induction charging device 4 relative to the receiving induction charging device 5 are carried out by means of at least one of the at least one positioning fields 9. This means that the receiving induction charging device 5 uses the at least one positioning field 9 to determine the relative position of the transmitting induction charging device 4 with respect to the receiving induction charging device 5, wherein at least one of the at least one positioning fields 9 also transmits the ID of the transmitting induction charging device 4. The main axis of the corresponding at least one positioning field 9, preferably of the respective positioning field 9, thus runs along the first direction R1, as in the case of the at least one ID field 6. In the exemplary embodiments shown, the respective ID field 6 is such a positioning field 9.

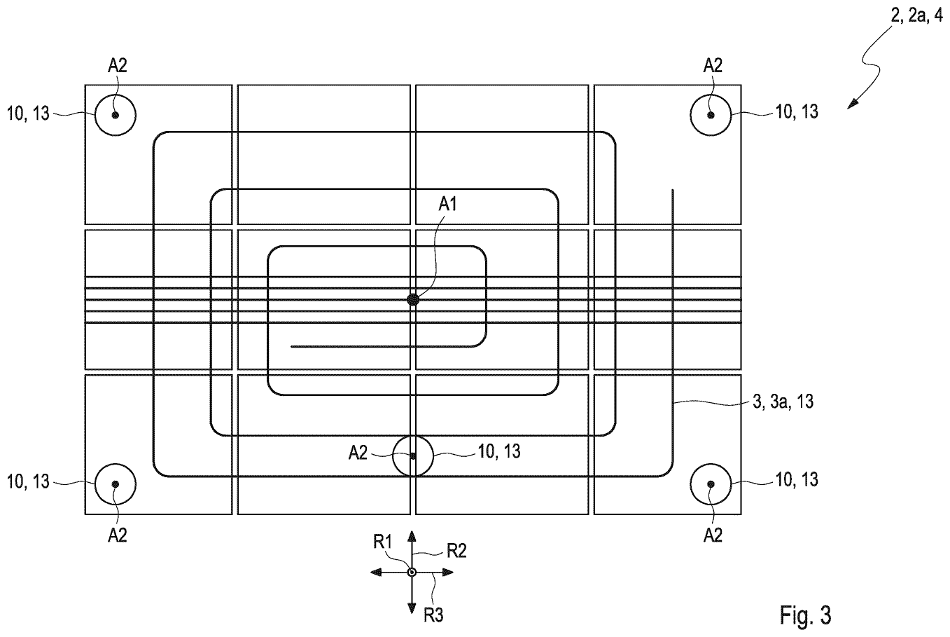

In the exemplary embodiments shown, the transmitting induction charging device 4 generates the respective ID field 6 and thus the respective positioning field 9 as a magnetic field. For this purpose, the transmitting induction charging device 4, as can be seen in FIGS. 1 and 3, has at least one coil 10, which will also be referred to as the transmission coil 10 in the following. In addition, the respective mobile induction charging device 5 in the exemplary embodiment shown has a receiver 11 for receiving the at least one ID field 6 and thus the positioning field 9. In the exemplary embodiment shown in FIG. 1, the receiver 11 is a coil 12, which is also referred to as the receiving coil 12 below. A navigation instruction is generated using at least one received positioning field 9, which is indicated by arrows in FIG. 1. In the exemplary embodiments shown, the navigation instruction is generated on the page of the mobile induction charging device 2, 2b and thus in the mobile application 100, i.e., in particular in the motor vehicle 101. The navigation instruction causes driving, in particular steering, of the application 100 for optimal or at least improved positioning of the induction charging devices 2 relative to each other for charging operation. The evaluation of the at least one received positioning field 9 and the generation and output of the navigation instruction can be carried out by means of a control device 103 of the application 100.

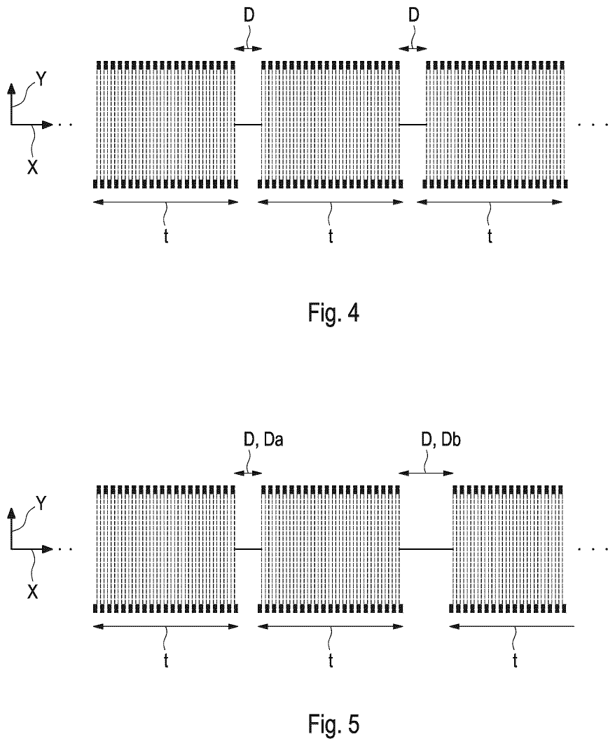

In the exemplary embodiments shown, the ID is transmitted using positioning field 9 by means of a temporary modification of at least one of the at least one positioning fields 9, as shown in FIGS. 4 and 5. FIGS. 4 and 5 show pulse width modulation, or PWM for short, with a constant duty cycle, which is applied to the transmission coil 10 generating the positioning field 9 in order to generate the positioning field 9. Here, the time progression is plotted along the indicated abscissa axis X and the strength of the pulse width modulation is plotted along the indicated ordinate axis Y. As can be seen from FIG. 4, a substantially constant magnetic field is generated as the positioning field 9 and thus as the ID field 6. The modification is carried out by means of a temporary change to the positioning field 9 at predetermined time intervals t and for a specific duration D. In the exemplary embodiment shown in FIG. 4, the time intervals t are all of equal length. In addition, in this exemplary embodiment, the duration D is the same in each case. The possible modification of positioning field 9 therefore takes place periodically in the exemplary embodiment shown. In the exemplary embodiments shown, the modification is achieved by changing the amplitude of the positioning field 9. This means that the ID is transmitted by means of a change in the otherwise essentially constant amplitude of the positioning field 9 at the specified time intervals t for the duration D. In the exemplary embodiments shown, the ID is also transmitted using a binary code composed of first symbols, for example a logical zero or “false,” and second symbols, for example a logical one or “true.” In the exemplary embodiment shown in FIG. 4, the first symbol is transferred by a temporary change in the positioning field 9, in the exemplary embodiments shown, i.e., a temporary change in the amplitude of the positioning field 9, i.e., a change in the amplitude for the duration D, and the second symbol is transmitted by the absence of this change. As indicated in FIG. 4, the change in amplitude is achieved by temporarily interrupting the pulse width modulation for a duration D and thus by reducing the amplitude of the positioning field 9, i.e., by temporarily suspending the positioning field 9 for the duration D. The positioning field 9 is therefore interrupted or suspended for the specified time intervals t for the duration D in order to transmit one of the symbols, for example the first symbol. If this temporary change remains, i.e., in the exemplary embodiments shown, the interruption or suspension of positioning field 9 at time intervals t for duration D, the second symbol is transmitted. The specified time intervals t can be, for example, 50 to 100 ms. The temporary change D and thus the duration of the change can be, for example, a few milliseconds, for example between 1 ms and 3 ms.

For example, to transmit the first symbol, the PWM and thus the positioning field 9 can be changed every 50 ms for 1 ms, in particular interrupted. To transmit the second symbol, the PWM and thus the positioning field 9 can remain unchanged every 50 ms for 1 ms. In FIG. 4, purely for illustrative purposes and for better understanding, it is assumed that the first symbol is transmitted sequentially in the area visible in FIG. 4.

The exemplary embodiment shown in FIG. 5 differs from the exemplary embodiment shown in FIG. 4 in that the symbols are transmitted by the same change in the positioning field 9, but for different durations D. In the exemplary embodiment shown, the first symbol is transmitted by suspending the amplitude for a first duration D, Da, and the second symbol is transmitted by suspending the amplitude for a second duration D, Db. In the exemplary embodiment shown, the second duration D, Db is purely exemplary and twice the first duration D, Da. In particular, the first duration D, Da may be 1 ms and the second duration D, Db may be 2 ms.

This makes it possible to transmit the binary code with any length and with as little interference as possible to the determination of the relative position of the transmitting induction charging device 4 to the receiving induction charging device 5, and thus with as little latency as possible.

It is also conceivable to transmit the start of transmission with a different modification (not shown). For this purpose, the PWM and thus positioning field 9 can be changed for 4 ms, or interrupted in particular. It is also conceivable to transmit the ID periodically.

For simplicity, any settling behavior is not shown in FIG. 4, but can of course be taken into account. In particular, due to the so-called “dead time,” the duration D and the time intervals t may be distorted on the receiving side, i.e., in the receiving induction charging device 5.

As can be seen in FIGS. 1 and 3, in the exemplary embodiments shown, the transmitting induction charging device 4 generates at least two such positioning fields 9 that are spatially offset from each other, wherein the transmitting induction charging device 4 has a corresponding transmission coil 10 for each positioning field 9 for this purpose. The respective positioning field 9 can be generated as such an ID field 6. This means that the transmitting induction charging device 4 can generate at least two such ID fields 6 for transmitting the ID. The ID can be transmitted by simultaneously modifying at least two of the at least two positioning fields 9. For clarity, FIG. 2 shows only one of the transmitting induction charging devices 4, i.e., in the exemplary embodiment shown, only one of the stationary induction charging devices 2, 2a, a single ID field 6 and thus positioning field 9.

As can be seen in FIG. 3, the transmitting induction charging device 4, i.e., in the exemplary embodiments shown, the respective stationary induction charging device 2, 2a, generates at least four, in the exemplary embodiments shown five, such positioning fields 9, which are spatially offset from one another. Accordingly, the transmitting induction charging device 4 has at least four, in the exemplary embodiments shown five, such transmission coils 10, which are arranged offset from one another. Only two of the transmitting coils 10 are visible in FIG. 1.

In accordance with FIGS. 1 and 3, in the exemplary embodiments shown, the respective transmission coil 10 differs from the energy coil 3 of the associated induction charging device 2, 4. As can be seen in FIG. 1, in the exemplary embodiments shown, receiver 11 and thus receiving coil 12 differ from energy coil 3 of the associated induction charging device 2, 5.

As can be seen in FIG. 3, in the exemplary embodiments shown, the respective energy coil 3 is designed as a flat coil 13 wound around a winding axis A1 running parallel to the first direction R1. In addition, in the exemplary embodiments shown, the respective transmission coil 10 is designed as a flat coil 13, which is wound around an associated winding axis A2 running parallel to the first direction R1.

1. A method for operating a charging system comprising at least one stationary induction charging device and at least one mobile induction charging device, the method comprising:
inductively coupling one of the at least one stationary induction charging device with one of the at least one mobile induction charging devices during a charging operation to transfer energy inductively;
arranging the stationary induction charging device and the mobile induction charging device opposite each other in a first direction during the charging operation;
prior to the charging operation, when the induction charging devices approach each other, operating one of the induction charging devices as a transmitting induction charging device and the other as a receiving induction charging device, such that:
the transmitting induction charging device generates at least one identifier (ID) field having a main axis along the first direction, the ID field transmitting an ID of the transmitting induction charging device;
the receiving induction charging device receives the ID of the transmitting induction charging device via the at least one ID field; and
establishing a data connection between the transmitting induction charging device and the receiving induction charging device based on the received ID.

2. The method according to claim 1, further comprising. performing a positioning operation in which the induction charging devices are positioned relative to each other for inductive energy transfer by:
the transmitting induction charging device generating at least one of the at least one ID field as a positioning field, and
the receiving induction charging device receiving the at least one positioning field,
wherein a relative position of the transmitting induction charging device with respect to the receiving induction charging device is determined based on the at least one positioning field received by the receiving induction charging device.

3. The method according to claim 2, wherein the transmitting induction charging device transmits the ID by modifying at least one of the at least one positioning fields.

4. The method according to claim 3, wherein the at least one positioning field is modified by changing the positioning field at predetermined time intervals.

5. The method according to claim 3, wherein the transmitting induction charging device transmits the ID by changing an amplitude of at least one of the at least one positioning fields at predetermined time intervals.

6. The method according to claim 1, wherein the transmitting induction charging device transmits the ID as a binary code comprising a first symbol and a second symbol.

7. The method according to claim 6, wherein the first symbol is transmitted by temporarily changing at least one of the at least one positioning fields and the second symbol is transmitted by absence of the change.

8. The method according to claim 6, wherein the first symbol is transmitted by suspending at least one of the at least one positioning fields and the second symbol is transmitted by not suspending the positioning field.

9. The method according to claim 6, wherein the first symbol is transmitted by changing, such as suspending, at least one of the at least one positioning fields for a first duration, and the second symbol is transmitted by changing, such as suspending, the at least one positioning field for a second duration.

10. The method according to claim 1, wherein the transmitting induction charging device generates at least one of the at least one ID fields as a magnetic field.

11. The method according to claim 10, wherein at least one of the at least one positioning fields is generated as a magnetic field by pulse width modulation, and the positioning field is modified by changing the pulse width modulation.

12. The method according to claim 3, wherein:
the transmitting induction charging device generates at least two positioning fields that are spatially offset from one another, and
the ID is transmitted by simultaneously modifying at least two of the at least two positioning fields.

13. The method according to claim 2, wherein the transmitting induction charging device generates at least four positioning fields that are spatially offset from one another.

14. The method according to claim 1, wherein the charging system comprises at least two stationary induction charging devices spaced apart from each other, each corresponding to a respective parking space of a parking lot.

15. The method according to claim 1, wherein the respective stationary induction charging device is operated as a transmitting induction charging device and the respective mobile induction charging device is operated as a receiving induction charging device.

16. A charging system comprising:
at least one stationary induction charging device;
at least one mobile induction charging device disposed in a motor vehicle; and
an infrastructure communicatively connected to the at least one stationary induction charging device and wirelessly communicatively connectable to the at least one mobile induction charging device;
wherein the charging system is configured to operate according to the method of claim 1, and
wherein a communicating link between the infrastructure and the induction charging device is different from the at least one ID field.

17. The charging system according to claim 16, wherein the charging system comprises a stationary induction charging device for at least two parking spaces of a parking lot, the stationary induction charging devices spaced apart from each other.

18. The method according to claim 1, wherein the data connection is separate from the at least one ID field.

19. The method according to claim 2, wherein the positioning operation starts prior to the charging operation.

20. The method according to claim 2, wherein the transmitting transmission induction charging device transmits the ID as a binary code comprising a first symbol and a second symbol.
